(19) United States
(12) Patent Application Publication
(10) Pub. No.: US 2026/0331606 A1
(43) Pub. Date: Oct. 22, 2026

(54) BATTERY PACK, CHARGER, CHARGING SYSTEM, AND METHOD FOR CHARGING BATTERY PACK WITH CHARGER

(71) Applicant: MAKITA CORPORATION, Anjo-shi (JP)

(72) Inventor: Junichi KATAYAMA, Anjo-shi (JP)

(73) Assignee: MAKITA CORPORATION, Anjo-shi (JP)

(21) Appl. No.: 19/468,583

(22) Filed: Feb. 3, 2026

(30) Foreign Application Priority Data
Feb. 7, 2025 (JP) 2025-019572

(51) Int. Cl. H01M 10/46; H01M 10/42; H01M 10/44; H01M 10/48; H01M 50/204; H02J 7/90; H02J 7/96

(52) U.S. Cl. CPC H01M 10/46; H01M 10/425; H01M 10/44; H01M 10/48; H01M 50/204; H02J 7/933; H02J 7/96

(57) ABSTRACT

One aspect of the present disclosure provides a battery pack including a battery module, an analog output generation circuit, and a control circuit. The control circuit is configured (i) to control the analog output generation circuit to generate an analog output voltage corresponding to a charge level of the battery module and (ii) to transmit communication data to a charger. The communication data includes parameters for the charger to generate a correlation profile. The correlation profile correlates a maximum required value of a charge current with the analog output voltage such that the maximum required value changes at two or more rates of change while the analog output voltage is transitioning among different voltage levels between a first voltage level and a second voltage level.

### CROSS-REFERENCE TO RELATED APPLICATIONS

This application claims the benefit of Japanese Patent Application No. 2025-019572 filed on Feb. 7, 2025 with the Japan Patent Office, the entire disclosure of which is incorporated herein by reference.

### BACKGROUND

The present disclosure relates to charging a battery pack.

Japanese Patent No. 6767198 discloses an example of battery packs for electric power tools, which includes a notification signal output circuit. The notification signal output circuit is configured to output, to a charger, an analog signal indicating a maximum charge current value that can be supplied to the battery pack. In the battery pack and the charger, a voltage of this analog signal is correlated with the maximum charge current value such that the maximum charge current value increases at a fixed rate of change as the voltage of the analog signal increases.

### SUMMARY

In recent years, in the electric power tool market, while battery pack capacities (i.e., ampere-hours) have increased, electric power tool users have demanded shorter charge times for battery packs. To meet this demand, the charge current must be increased.

However, in the above example of battery packs, increasing the maximum charge current value to reduce charge time also necessitates increasing the rate of change for the maximum charge current value with respect to the change in the voltage of the analog signal. In this case, the maximum charge current value changes significantly in response to subtle changes in the voltage of the analog signal; consequently, the charger may fail to precisely control the charge current.

In one aspect of the present disclosure, it is desirable to be able to provide a technique for enabling an analog output voltage from a battery pack to more precisely control a large charge current from a charger.

In the present disclosure, ordinal numbers such as “first” and “second” are merely intended to distinguish elements from each other, and are not intended to limit the order or number of the elements. Therefore, the first element may be referred to as the second element, and similarly, the second element may be referred to as the first element. In addition, the first element may be provided without the second element, and similarly, the second element may be provided without the first element.

One aspect of the present disclosure provides a battery pack including a battery module, an analog output generation circuit, and a control circuit.

The battery module is configured (i) to receive a charge current from a charger and (ii) to be charged by the charge current.

The analog output generation circuit is configured (i) to generate an analog output voltage and (ii) to output the analog output voltage to the charger. The analog output voltage is variable among different voltage levels between a first voltage level and a second voltage level higher than the first voltage level.

The control circuit is configured (i) to control the analog output generation circuit to generate the analog output voltage corresponding to a charge level of the battery module and (ii) to transmit communication data to the charger. The communication data includes parameters for the charger to generate a correlation profile. The correlation profile correlates a maximum required value of the charge current with the analog output voltage such that the maximum required value changes at two or more rates of change while the analog output voltage is transitioning among the different voltage levels. The charger is configured to change the maximum required value based on the analog output voltage and the correlation profile to thereby control a magnitude of the charge current.

According to the battery pack configured in this way, while the analog output voltage is transitioning among the different voltage levels, the maximum required value can be changed at two or more rates of change at the charger, and consequently, the magnitude of the charge current can also be changed at two or more rates of change.

Accordingly, if the correlation profile is defined such that the maximum required value changes at two or more appropriate rates of change, this battery pack can control a large charge current more precisely using the analog output voltage.

Another aspect of the present disclosure provides a charger including a power-supply circuit and a control circuit.

The power-supply circuit is configured (i) to generate a charge current and (ii) to output the charge current to a battery pack.

The control circuit is configured (i) to receive an analog output voltage and communication data from the battery pack, (ii) to change a maximum required value of the charge current based on the analog output voltage and parameters included in the communication data, and (iii) to control the power-supply circuit to change a magnitude of the charge current in response to a change of the maximum required value. The analog output voltage is variable among different voltage levels between a first voltage level and a second voltage level higher than the first voltage level. The parameters correlate the maximum required value with the analog output voltage such that the maximum required value changes at two or more rates of change while the analog output voltage is transitioning among the different voltage levels.

In the charger configured in this way, while the analog output voltage is transitioning among the different voltage levels, the maximum required value can be changed at the two or more rates of change, and consequently, the magnitude of the charge current can also be changed at two or more rates of change.

Accordingly, if the correlation profile is defined such that the maximum required value changes at two or more appropriate rates of change, this charger can control a large charge current more precisely using the analog output voltage.

Yet another aspect of the present disclosure provides a charging system including a battery pack and a charger.

The battery pack includes a battery module, an analog output generation circuit, and a first control circuit.

The battery module is configured (i) to receive a charge current from the charger and (ii) to be charged by the charge current.

The analog output generation circuit is configured (i) to generate an analog output voltage and (ii) to output the analog output voltage to the charger. The analog output voltage is variable among different voltage levels between a first voltage level and a second voltage level higher than the first voltage level.

The first control circuit is configured (i) to control the analog output generation circuit to generate the analog output voltage corresponding to a charge level of the battery module and (ii) to transmit communication data to the charger. The communication data includes parameters for the charger to generate a correlation profile. The correlation profile correlates a maximum required value of the charge current with the analog output voltage such that the maximum required value changes at two or more rates of change while the analog output voltage is transitioning among the different voltage levels.

The charger includes a power-supply circuit and a second control circuit.

The power-supply circuit is configured (i) to generate the charge current and (ii) to output the charge current to the battery pack.

The second control circuit is configured (i) to receive the analog output voltage and the communication data, (ii) to generate the correlation profile based on the parameters included in the communication data, (iii) to change the maximum required value based on the analog output voltage and the correlation profile, and (iv) to control the power-supply circuit to change a magnitude of the charge current based on the maximum required value.

In the charging system configured in this way, while the analog output voltage is transitioning among the different voltage levels, the maximum required value can be changed at the two or more rates of change at the charger, and consequently, the magnitude of the charge current can also be changed at two or more rates of change.

Accordingly, if the correlation profile is defined such that the maximum required value changes at two or more appropriate rates of change, this charging system can control a large charge current more precisely using the analog output voltage.

Yet another aspect of the present disclosure provides a method for charging a battery pack with a charger, the method including:
outputting an analog output voltage from the battery pack to the charger, the analog output voltage being variable among different voltage levels between a first voltage level and a second voltage level higher than the first voltage level;
receiving, at the charger, the analog output voltage; and
changing, at the charger, a maximum required value of a charge current for charging the battery pack based on the analog output voltage and a correlation profile to thereby control a magnitude of the charge current, the correlation profile correlating the maximum required value with the analog output voltage such that the maximum required value changes at two or more rates of change while the analog output voltage is transitioning among the different voltage levels.

According to this method, if the correlation profile is defined such that the maximum required value changes at two or more appropriate rates of change, it is possible to control a large charge current more precisely using the analog output voltage.

### BRIEF DESCRIPTION OF THE DRAWINGS

An example embodiment of the present disclosure will be described hereinafter with reference to the accompanying drawings, in which:

FIG. 1 is a block diagram showing an overall configuration of a charging system;

FIG. 2A is a block diagram schematically showing a circuit configuration of a first battery pack;

FIG. 2B is a circuit diagram showing in detail an analog output generation circuit;

FIG. 3 is a block diagram schematically showing a circuit configuration of a first charger;

FIG. 4 shows a first correlation profile;

FIG. 5 shows a second correlation profile;

FIG. 6A is a part of a flowchart showing an operation of the charging system when any one of the first battery pack, a second battery pack, and a third battery pack is connected to the first charger;

FIG. 6B is the remaining part of the flowchart showing the operation of the charging system when any one of the first through third battery packs is connected to the first charger;

FIG. 7A is a part of a flowchart showing an operation of the charging system when the first battery pack is connected to a second charger or a third charger;

FIG. 7B is the remaining part of the flowchart showing the operation of the charging system when the first battery pack is connected to the second charger or the third charger;

FIG. 8 is a flowchart showing a first control process to be executed by a first control circuit of the first battery pack;

FIG. 9 is a flowchart showing a second control process to be executed by a second control circuit of the first charger; and

FIG. 10 shows a modified example of the first correlation profile.

### DETAILED DESCRIPTION OF EXEMPLARY EMBODIMENTS

### 1. Overview of Embodiments

One embodiment may include at least any one of:
Feature 1: a battery pack includes a battery module configured (i) to receive a charge current from a charger and (ii) to be charged by the charge current;
Feature 2: the battery pack includes an analog output generation circuit configured (i) to generate an analog output voltage and (ii) to output the analog output voltage to the charger;
Feature 3: the analog output voltage is variable (or varies) among different voltage levels between a first voltage level and a second voltage level higher than the first voltage level;
Feature 4: the battery pack includes a control circuit;
Feature 5: the control circuit is configured (or programmed) to control the analog output generation circuit to generate the analog output voltage corresponding to a charge level of the battery module;
Feature 6: the control circuit is configured (or programmed) to transmit communication data to the charger;
Feature 7: the communication data includes parameters for the charger to generate (or create) a correlation profile;
Feature 8: the correlation profile correlates a maximum required value of the charge current with the analog output voltage such that the maximum required value changes at two or more rates of change while the analog output voltage is transitioning among the different voltage levels (or as the analog output voltage varies among the different voltage levels); and
Feature 9: the charger is configured to change the maximum required value based on the analog output voltage and the correlation profile to thereby control (or adjust or regulate) a magnitude of the charge current.

According to an embodiment including at least Features 1 through 9, while the analog output voltage is transitioning among the different voltage levels, the maximum required value can be changed at the two or more rates of change at the charger, and consequently, the magnitude of the charge current can also be changed at two or more rates of change.

Accordingly, if the correlation profile is defined such that the maximum required value changes at two or more appropriate rates of change, this battery pack can control (or adjust or regulate) a large charge current (or a high charge current) more precisely using the analog output voltage.

One embodiment may include, in addition to or in place of at least any one of Features 1 through 9, at least any one of:
Feature 10: the analog output voltage has an unsaturated voltage range including the different voltage levels between the first voltage level and the second voltage level;
Feature 11: the unsaturated voltage range is divided into at least two voltage ranges in the correlation profile; and
Feature 12: the maximum required value changes at different rates of change across adjacent voltage ranges of the at least two voltage ranges in the correlation profile.

One embodiment may include, in addition to or in place of at least any one of Features 1 through 12, at least any one of:
Feature 13: the control circuit is configured (or programmed) to control the analog output generation circuit to decrease the analog output voltage in accordance with an increase in the charge level;
Feature 14: the at least two voltage ranges include (i) a first voltage range and (ii) a second voltage range adjacent to and higher than the first voltage range; and
Feature 15: in the correlation profile, the maximum required value has a first rate of change in the first voltage range and a second rate of change higher than the first rate of change in the second voltage range.

According to an embodiment including at least Features 1 through 15, it is possible to control the magnitude of the charge current such that the charge current is increased when the charge level is low and the charge current is decreased when the charge level is high. With this control, overcharge of the battery module can be suppressed while shortening a charge time.

One embodiment may include, in addition to or in place of at least any one of Features 1 through 15,
Feature 16: the second rate of change is three times the first rate of change.

One embodiment may include, in addition to or in place of at least any one of Features 1 through 16, at least any one of:
Feature 17: the unsaturated voltage range is divided into 24 equal intervals; and
Feature 18: a total number of equal intervals included in the first voltage range is equal to a total number of equal intervals included in the second voltage range.

One embodiment may include, in addition to or in place of at least any one of Features 1 through 18, at least any one of:
Feature 19: the parameters include at least two pairs (or two or more pairs) of parameters; and
Feature 20: each pair of the at least two pairs of parameters includes (i) a first parameter indicating a rate of change for the maximum required value and (ii) a second parameter indicating the number of equal intervals to which the rate of change indicated by the first parameter is applied.

According to an embodiment including at least Features 1 through 12, 17, 19, and 20, it is possible to reduce the volume of communication required for the charger to generate the correlation profile. As a result, the likelihood that the charger fails to receive the communication data can be reduced, and consequently, stable charge control can be performed between the charger and the battery pack.

One embodiment may include, in addition to or in place of at least any one of Features 1 through 20, at least any one of:
Feature 21: the at least two pairs of parameters are five pairs of parameters;
Feature 22: the correlation profile is defined by at least two pairs and at most four pairs among the five pairs of parameters; and
Feature 23: each remaining pair of the five pairs of parameters indicates a numerical value of zero.

According to an embodiment including at least Features 1 through 12, 17, and 19 through 21, not only simple correlation profiles but also more complex correlation profiles can be defined by the parameters.

One embodiment may include, in addition to or in place of at least any one of Features 1 through 23,
Feature 24: the control circuit is configured (or programmed) to transmit the communication data to the charger via serial communication with the charger.

One embodiment may include, in addition to or in place of at least any one of Features 1 through 24, at least any one of:
Feature 25: the analog output generation circuit includes a capacitor and a semiconductor switch; and
Feature 26: the analog output generation circuit is configured such that the capacitor generates the analog output voltage by being charged or discharged through the semiconductor switch.

According to an embodiment including at least Features 1 through 9, 25, and 26, the analog output voltage can be stabilized by the capacitor.

One embodiment may include, in addition to or in place of at least any one of Features 1 through 26,
Feature 27: the control circuit is configured (or programmed) to transmit (or provide or output), to the semiconductor switch, a pulse-width modulated signal having a duty ratio (or a duty cycle) corresponding to the maximum required value to thereby control a switching operation of the semiconductor switch.

According to an embodiment including at least Features 1 through 9 and 25 through 27, the analog output voltage can be controlled by the pulse-width modulated signal.

Examples of the semiconductor switch include, but are not limited to, metal-oxide semiconductor field-effect transistors (MOSFET), junction field-effect transistors (JFETs), metal-semiconductor field-effect transistors (MESFETs), bipolar transistors, insulated-gate bipolar transistors (IGBTs), solid-state relays (SSR), and thyristors.

One embodiment may include at least any one of:
Feature 28: a charger includes a power-supply circuit configured (i) to generate a charge current and (ii) to output the charge current to a battery pack;
Feature 29: the charger includes a control circuit;
Feature 30: the control circuit is configured (or programmed) to receive an analog output voltage and communication data from the battery pack;
Feature 31: the control circuit is configured (or programmed) to change a maximum required value of the charge current based on the analog output voltage and parameters included in the communication data;
Feature 32: the control circuit is configured (or programmed) to control the power-supply circuit to change (or adjust or regulate) a magnitude of the charge current in response to a change of the maximum required value; and
Feature 33: the analog output voltage is variable (or varies) among different voltage levels between a first voltage level and a second voltage level higher than the first voltage level;
Feature 34: the parameters correlates the maximum required value with the analog output voltage such that the maximum required value changes at two or more rates of change while the analog output voltage is transitioning among the different voltage levels (or as the analog output voltage varies among the different voltage levels).

In an embodiment including at least Features 28 through 34, while the analog output voltage is transitioning among the different voltage levels, the maximum required value can be changed at the two or more rates of change, and consequently, the magnitude of the charge current can also be changed at two or more rates of change.

Accordingly, if the correlation profile is defined such that the maximum required value changes at two or more appropriate rates of change, this charger can control (or adjust or regulate) a large charge current (or a high charge current) more precisely using the analog output voltage.

One embodiment may include at least any one of:
Feature 35: a charging system includes a battery pack;
Feature 36: the charging system includes a charger;
Feature 37: the battery pack includes a battery module configured (i) to receive a charge current from the charger and (ii) to be charged by the charge current;
Feature 38: the battery pack includes an analog output generation circuit configured (i) to generate an analog output voltage and (ii) to output the analog output voltage to the charger;
Feature 39: the analog output voltage is variable (or varies) among different voltage levels between a first voltage level and a second voltage level higher than the first voltage level;
Feature 40: the battery pack includes a first control circuit;
Feature 41: the first control circuit is configured (or programmed) to control the analog output generation circuit to generate the analog output voltage corresponding to a charge level of the battery module;
Feature 42: the first control circuit is configured (or programmed) to transmit communication data to the charger;
Feature 43: the communication data includes parameters for the charger to generate (or create) a correlation profile;
Feature 44: the correlation profile correlates a maximum required value of the charge current with the analog output voltage such that the maximum required value changes at two or more rates of change while the analog output voltage is transitioning among the different voltage levels (or as the analog output voltage varies among the different voltage levels);
Feature 45: the charger includes a power-supply circuit configured (i) to generate the charge current and (ii) to output the charge current to the battery pack;
Feature 46: the charger includes a second control circuit;
Feature 47: the second control circuit is configured (or programmed) to receive the analog output voltage and the communication data;
Feature 48: the second control circuit is configured (or programmed) to generate (or create) the correlation profile based on the parameters included in the communication data;
Feature 49: the second control circuit is configured (or programmed) to change the maximum required value based on the analog output voltage and the correlation profile; and
Feature 50: the second control circuit is configured (or programmed) to control the power-supply circuit to change a magnitude of the charge current based on the maximum required value.

In an embodiment including at least Features 35 through 50, while the analog output voltage is transitioning among the different voltage levels, the maximum required value can be changed at the two or more rates of change at the charger, and consequently, the magnitude of the charge current can also be changed at two or more rates of change.

Accordingly, if the correlation profile is defined such that the maximum required value changes at two or more appropriate rates of change, this charging system can control (or adjust or regulate) a large charge current (or a high charge current) more precisely using the analog output voltage.

In one embodiment, the first control circuit or the second control circuit may be integrated into a single electronic unit, a single electronic device, or a single circuit board.

In one embodiment, the first control circuit or the second control circuit may be a combination of two or more electronic circuits, two or more electronic units, or two or more electronic devices separately provided in the battery pack or in the charger.

In one embodiment, the first control circuit or the second control circuit may include a microcomputer (or a microcontroller or a microprocessor), wired logic, a graphics processing unit (GPU), an application-specific integrated circuit (ASIC), an application-specific standard product (ASSP), a programmable logic device (PLD) such as a field-programmable gate array (FPGA), discrete electronic components, and/or any combination thereof.

One embodiment may include at least any one of:
Feature 51: outputting an analog output voltage from a battery pack to a charger;
Feature 52: the analog output voltage is variable (or varies) among different voltage levels between a first voltage level and a second voltage level higher than the first voltage level;
Feature 53: receiving, at the charger, the analog output voltage;
Feature 54: changing, at the charger, a maximum required value of a charge current for charging the battery pack based on the analog output voltage and a correlation profile to thereby control (or adjust or regulate) a magnitude of the charge current; and
Feature 55: the correlation profile correlates the maximum required value with the analog output voltage such that the maximum required value changes at two or more rates of change while the analog output voltage is transitioning among the different voltage levels (or as the analog output voltage varies among the different voltage levels).

According to an embodiment including at least Features 51 through 55, if the correlation profile is defined such that the maximum required value changes at two or more appropriate rates of change, it is possible to control (or adjust or regulate) a large charge current (or a high charge current) more precisely using the analog output voltage.

In one embodiment, the battery pack may be detachably attached to an electric work machine and may supply DC power to the electric work machine.

Examples of the electric work machine include various types of job-site electric devices used for DIY, manufacturing, gardening, or construction, which are configured to be battery-powered. Such electric work machines specifically include electric power tools for masonry work, metalworking, or woodworking, work machines for gardening, and devices for preparing a job-site environment. More specifically, the electric work machine may include, but is not limited to: electric blowers, electric hammers, electric hammer drills, electric drills, electric drivers, electric wrenches, electric grinders, electric circular saws, electric reciprocating saws, electric jig saws, electric cutters, electric chain saws, electric planes, electric nailing machines (including tackers), electric hedge trimmers, electric lawn mowers, electric lawn trimmers, electric bush or grass cutters, electric cleaners, electric sprayers, electric spreaders, electric dust collectors, laser rangefinders (or laser distance measuring instruments), laser markers, beam receivers for laser markers, wall scanners, radios, TVs, speakers, electric hot or cool storages, electric kettles, coffee machines (or coffee makers or coffee distillers), microwave ovens, robot vacuum cleaners, battery-powered wheelbarrows, battery-powered bicycles, fan vests, and heating jackets.

In one embodiment, Features 1 through 55 may be combined in any combination.

In one embodiment, any of Features 1 through 55 may be excluded.

### 2. Specific Example Embodiments

Specific example embodiments will be described below. The specific example embodiments exemplify a charging system 1 described below.

### 2-1. Overall Configuration of Charging System

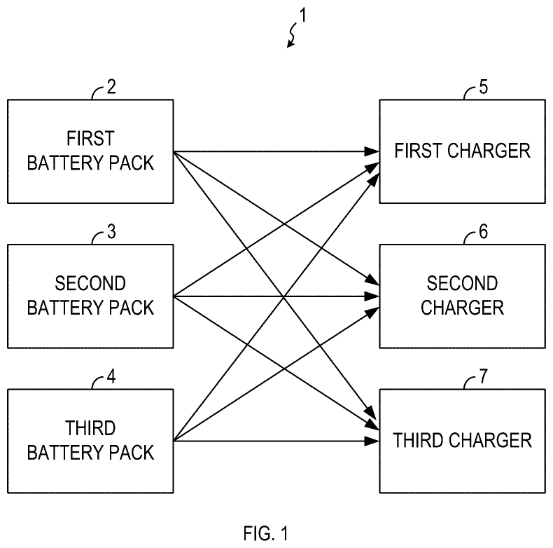

As shown in FIG. 1, the charging system 1 includes a first battery pack 2, a second battery pack 3, and a third battery pack 4, as well as a first charger 5, a second charger 6, and a third charger 7.

Each of the first through third battery packs 2 through 4 is configured to be detachably attached to any corresponding electric work machine (not shown), and to supply DC power to the electric work machine.

Each of the first through third chargers 5 through 7 is configured to be compatible with each of the first through third battery packs 2 through 4, such that any one of the first through third battery packs 2 through 4 is detachably connected thereto for charging the connected battery pack.

In another embodiment, at least any one of the second battery pack 3, the third battery pack 4, the second charger 6, and the third charger 7 may be excluded from the charging system 1.

### 2-2. Circuit Configurations of First through Third Battery Packs

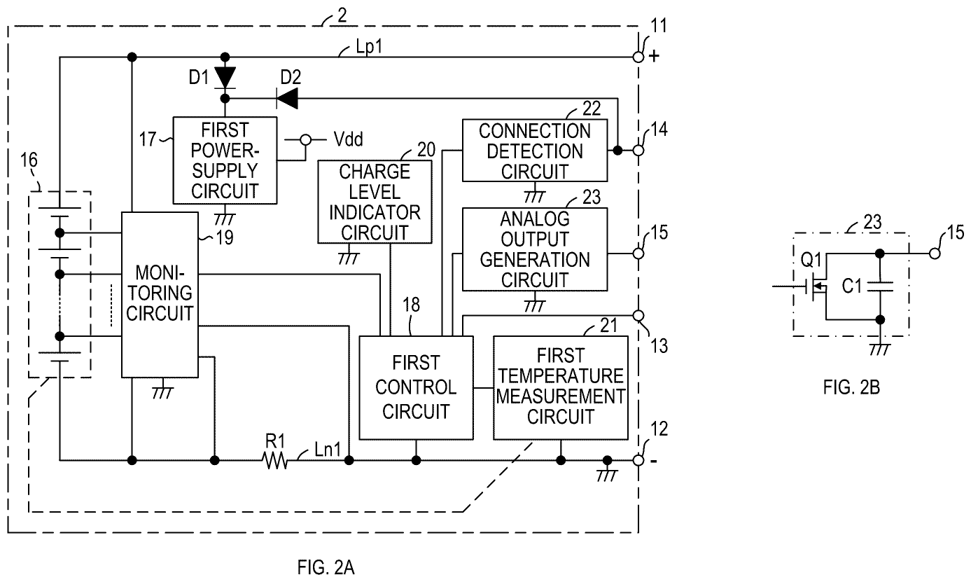

As shown in FIG. 2A, the first battery pack 2 includes a first positive electrode terminal 11, a first negative electrode terminal 12, a first data communication terminal 13, a Vcc input terminal 14, an analog output terminal 15, a first positive current path Lp1, a first negative current path Ln1, a first diode D1, a second diode D2, a shunt resistor R1, a battery module 16, a first power-supply circuit 17, a first control circuit 18, a monitoring circuit 19, a charge level indicator circuit 20, a first temperature measurement circuit 21, a connection detection circuit 22, and an analog output generation circuit 23.

The first positive electrode terminal 11 is coupled to the first positive current path Lp1, which extends from the first positive electrode terminal 11 to a positive electrode of the battery module 16, thereby electrically coupled to the positive electrode of the battery module 16. In addition, the first positive electrode terminal 11 is coupled to an anode of the first diode D1 through the first positive current path Lp1.

The first negative electrode terminal 12 is coupled to the first negative current path Ln1, which extends from the first negative electrode terminal 12 to a negative electrode of the battery module 16, thereby electrically coupled to the negative electrode of the battery module 16.

Each of the first positive current path Lp1 and the first negative current path Ln1 is configured to carry (or conduct) (i) a charge current Ichg to be supplied to the battery module 16 from any one of the first through third chargers 5 through 7 connected to the first battery pack 2 and (ii) a discharge current Idis to be supplied from the battery module 16 to an electric work machine connected to the first battery pack 2. The first negative current path Ln1 is coupled to the ground of the first battery pack 2. The ground is also coupled to the first power-supply circuit 17, the first control circuit 18, the monitoring circuit 19, the charge level indicator circuit 20, the first temperature measurement circuit 21, the connection detection circuit 22, and the analog output generation circuit 23, thereby serving as the reference potential (or the reference voltage) for these circuits.

The shunt resistor R1 is provided in the first negative current path Ln1 such that the charge current Ichg and the discharge current Idis pass through the shunt resistor R1.

The first data communication terminal 13 is coupled to the first control circuit 18. The first data communication terminal 13 is a terminal for serial communication between the first control circuit 18 and any one of the first through third chargers 5 through 7 connected to the first battery pack 2.

The Vcc input terminal 14 is coupled to (i) an anode of the second diode D2 and (ii) the connection detection circuit 22.

The analog output terminal 15 is coupled to the analog output generation circuit 23.

The battery module 16 includes, between its positive electrode and negative electrode, two or more rechargeable battery cells connected in series and/or in parallel. Each rechargeable battery cell is a lithium ion battery, but is not limited thereto.

The first power-supply circuit 17 is a DC-DC converter coupled to a cathode of the first diode D1 and a cathode of the second diode D2 and configured to generate a first power supply voltage Vdd. The cathode of the first diode D1 is coupled to the cathode of the second diode D2. Accordingly, the first power-supply circuit 17 is configured to generate the first power supply voltage Vdd based on the higher of (i) a voltage between the positive and negative electrodes of the battery module 16 (hereinafter, referred to as the ‘battery voltage Vbat’) and (ii) a second power supply voltage Vcc supplied to the Vcc input terminal 14. The first power supply voltage Vdd is supplied to the first control circuit 18, the monitoring circuit 19, the charge level indicator circuit 20, the first temperature measurement circuit 21, and the connection detection circuit 22 to operate these circuits. The battery voltage Vbat is a DC voltage of 18 volts, but is not limited thereto. In another embodiment, the battery voltage Vbat may be a DC voltage of 40 volts, 14.4 volts, or 10.8 volts. Each of the first power supply voltage Vdd and the second power supply voltage Vcc is a DC voltage of 5 volts, but is not limited thereto.

The first control circuit 18 is configured to transmit various signals to, and receive various signals from, other circuits, thereby controlling charging and discharging of the battery module 16. More specifically, the first control circuit 18 is a microcomputer including a central processing unit (CPU), a memory, an input/output (I/O) port, a serial communication interface (SCI), a digital-to-analog converter (DAC), and an analog-to-digital converter (ADC), but is not limited thereto. In another embodiment, the first control circuit 18 may include an additional microcomputer. In yet another embodiment, the first control circuit 18 may include, in addition to or in place of the microcomputer, a logic circuit (or a wired logic connection) including two or more electronic components. In yet another embodiment, the first control circuit 18 may include, in addition to or in place of the microcomputer, a GPU, an ASIC, an ASSP, and/or a PLD.

The monitoring circuit 19 is configured to monitor (i) the battery voltage Vbat, (ii) all individual voltages of the rechargeable battery cells (hereinafter each referred to as the ‘cell voltage Vcel’), and (iii) a voltage across the shunt resistor R1 (i.e., a magnitude of the charge current Ichg or the discharge current Idis). The monitoring circuit 19 is also configured to balance (or equalize) all the cell voltages Vcels. The monitoring circuit 19 is further configured to send, to the first control circuit 18 via serial communication with the first control circuit 18, a monitoring result indicating (i) the battery voltage Vbat, (ii) all the cell voltages Vcels, and (iii) the voltage across the shunt resistor R1. The first control circuit 18 is configured (or programmed) to determine (or detect) (i) the battery voltage Vbat, (ii) all the cell voltages Vcels, and (iii) the voltage across the shunt resistor R1 based on the received monitoring result. In another embodiment, the first control circuit 18 may be integrated with the monitoring circuit 19. In yet another embodiment, the monitoring circuit 19 may be configured (i) not to monitor at least any one of the cell voltages Vcels or (ii) not to balance (or equalize) all the cell voltages Vcels. Alternatively, the monitoring circuit 19 may be excluded from the first battery pack 2. Such a circuit configuration, although less preferred, is encompassed within the scope of the present disclosure.

The charge level indicator circuit 20 is configured to receive an indicator control signal from the first control circuit 18 and, according to the received indicator control signal, to display a charge level of the first battery pack 2 (more specifically, the battery module 16) using a light source such as a light-emitting diode (LED), a seven-segment display, and/or a liquid crystal display (LCD). The indicator control signal specifies a display pattern corresponding to the battery voltage Vbat determined by the first control circuit 18. In another embodiment, the charge level indicator circuit 20 may be excluded from the first battery pack 2.

The first temperature measurement circuit 21 is configured to measure the temperature of the battery module 16 (hereinafter referred to as the ‘battery temperature Tbat’) using a not-shown temperature detection element (for example, a thermistor) and to transmit a first temperature measurement signal to the first control circuit 18. The first temperature measurement signal is an analog signal having a variable voltage corresponding to the battery temperature Tbat. The first control circuit 18 is configured (or programmed) to determine the battery temperature That based on a voltage of the first temperature measurement signal. In another embodiment, the first temperature measurement circuit 21 may be excluded from the first battery pack 2. Such a circuit configuration, although less preferred, is encompassed within the scope of the present disclosure.

The connection detection circuit 22 is configured to detect whether the second power supply voltage Vcc is supplied to the Vcc input terminal 14 and to transmit a connection detection signal to the first control circuit 18. The connection detection signal is a digital signal, more specifically, a negative logic signal (or an active-low signal). The connection detection circuit 22 is configured (i) to assert the connection detection signal in response to the second power supply voltage Vcc being supplied to the Vcc input terminal 14 and (ii) to negate the connection detection signal in response to the second power supply voltage Vcc not being supplied to the Vcc input terminal 14. The first control circuit 18 is configured (or programmed) (i) to determine, in response to receiving the asserted connection detection signal, that the first battery pack 2 is connected to any one of the first through third chargers 5 through 7, and (ii) to determine, in response to receiving the negated connection detection signal, that the first battery pack 2 is not connected to any one of the first through third chargers 5 through 7. In another embodiment, the connection detection signal may be a positive logic signal (or an active-high signal).

The analog output generation circuit 23 is configured to receive a pulse-width modulated (PWM) signal from the first control circuit 18 and to generate an analog output voltage Vout according to the received PWM signal. The first control circuit 18 is configured (or programmed) to change a maximum required value Imax of the charge current Ichg based on at least the battery voltage Vbat determined by the first control circuit 18, and to change a duty ratio (or a duty cycle) of the PWM signal in association with the change of the maximum required value Imax. More specifically, the first control circuit 18 is configured (or programmed) (i) to increase the maximum required value Imax in response to a low battery voltage Vbat (i.e., a charge level of the battery module 16) and (ii) to decrease the maximum required value Imax in response to a high battery voltage Vbat. The resulting analog output voltage Vout changes among various voltage levels corresponding to the change of the maximum required value Imax.

As shown in detail in FIG. 2B, the analog output generation circuit 23 includes a capacitor C1 and a semiconductor switch Q1 coupled in parallel with each other. The capacitor C1 includes a first terminal coupled to the analog output terminal 15. The capacitor C1 also includes a second terminal coupled to the ground of the first battery pack 2. The semiconductor switch Q1 is configured to receive the PWM signal from the first control circuit 18 and to be turned on or off according to the received PWM signal. Specifically, the analog output generation circuit 23 is configured such that (i) the capacitor C1 is charged with an electric current drawn from the analog output terminal 15 into the capacitor C1 in response to the semiconductor switch Q1 being turned off, and (ii) the capacitor C1 is discharged to ground through the semiconductor switch Q1 in response to the semiconductor switch Q1 being turned on. The semiconductor switch Q1 is an n-channel MOSFET, but is not limited thereto. In another embodiment, the semiconductor switch Q1 may be any one of other types of semiconductor switches including JFETs, MESFETs, bipolar transistors, IGBTs, SSRs, and thyristors.

Each of the second battery pack 3 and the third battery pack 4 has a circuit configuration similar to that of the first battery pack 2. In other words, each of the second battery pack 3 and the third battery pack 4 includes all the aforementioned components of the first battery pack 2.

However, the first through third battery packs 2 through 4 differ from one another in terms of (i) specifications or characteristics of their respective components, (ii) signals transmitted from their respective first control circuits 18, and (iii) processes executed by their respective first control circuits 18.

One such difference is that the first through third battery packs 2 through 4 (specifically, their respective battery modules 16, and more specifically, their respective rechargeable battery cells) have different charge rates.

Among the first through third battery packs 2 through 4, the first battery pack 2 has the highest charge rate, the second battery pack 3 has the second highest charge rate, and the third battery pack 4 has the lowest charge rate.

Due to these differences in charge rates, the first through third battery packs 2 through 4 have different upper limit values (or maximum values or permissible values) of the charge current Ichg. The first battery pack 2 has a first upper limit value of the charge current Ichg. The second battery pack 3 has a second upper limit value of the charge current Ichg, which is lower than the first upper limit value. The third battery pack 4 has a third upper limit value of the charge current Ichg, which is lower than the second upper limit value.

The battery modules 16 of the first through third battery packs 2 through 4 may have the same capacity (i.e., ampere-hour), or they may have different capacities.

In the present embodiment, the battery modules 16 of the first through third battery packs 2 through 4 are assumed to have the same capacity, specifically, a capacity of 12 ampere-hours. In addition, it is assumed that the first battery pack 2 has a charge rate of 2 C; the second battery pack 3 has a charge rate of 1 C; and the third battery pack 4 has a charge rate of 0.75 C. Under such an assumption, the first through third upper limit values are set to 24 amperes, 12 amperes, and 9 amperes, respectively.

### 2-3. Circuit Configurations of First through Third Chargers

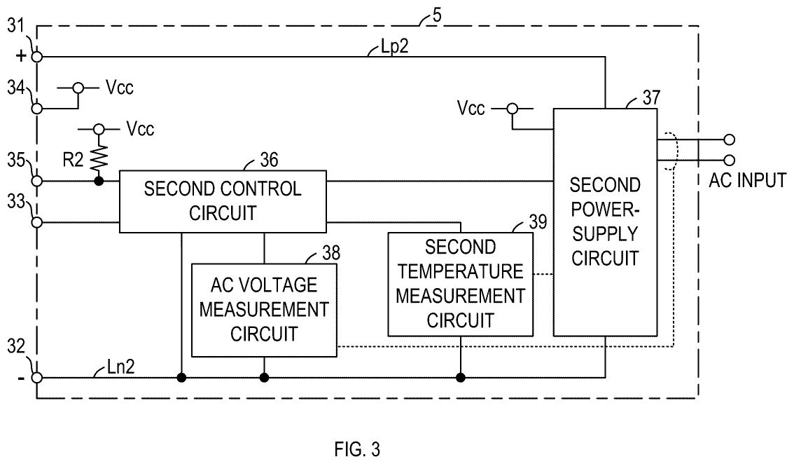

As shown in FIG. 3, the first charger 5 includes a second positive electrode terminal 31, a second negative electrode terminal 32, a second data communication terminal 33, a Vcc output terminal 34, an analog input terminal 35, a second positive current path Lp2, a second negative current path Ln2, a pull-up resistor R2, a second control circuit 36, a second power-supply circuit 37, an AC voltage measurement circuit 38, and a second temperature measurement circuit 39.

The second positive electrode terminal 31 is coupled to the second positive current path Lp2, which extends from the second positive electrode terminal 31 to a positive electrode terminal of the second power-supply circuit 37, thereby electrically coupled to the positive electrode terminal of the second power-supply circuit 37. The second positive electrode terminal 31 is configured to be detachably connected to the first positive electrode terminal 11 of any one of the first through third battery packs 2 through 4 connected to the first charger 5.

The second negative electrode terminal 32 is coupled to the second negative current path Ln2, which extends from the second negative electrode terminal 32 to a negative electrode terminal of the second power-supply circuit 37, thereby electrically coupled to the negative electrode terminal of the second power-supply circuit 37. The second negative electrode terminal 32 is configured to be detachably connected to the first negative electrode terminal 12 of any one of the first through third battery packs 2 through 4 connected to the first charger 5. Accordingly, in response to any one of the first through third battery packs 2 through 4 being connected to the first charger 5, the second negative current path Ln2 is coupled to the ground of the connected battery pack, so that the first charger 5 shares a common reference potential with the connected battery pack.

Each of the second positive current path Lp2 and the second negative current path Ln2 is configured to carry (or conduct) the charge current Ichg. The second negative current path Ln2 is also coupled to the second control circuit 36, the AC voltage measurement circuit 38, and the second temperature measurement circuit 39, thereby serving as the reference potential (or the reference voltage) for these circuits.

The second data communication terminal 33 is coupled to the second control circuit 36. The second data communication terminal 33 is also configured to be detachably connected to the first data communication terminal 13 of any one of the first through third battery packs 2 through 4 connected to the first charger 5. The second data communication terminal 33 is a terminal for serial communication between the second control circuit 36 and the first control circuit 18 of any one of the first through third battery packs 2 through 4 connected to the first charger 5.

The Vcc output terminal 34 is configured to receive the second power supply voltage Vcc from the second power-supply circuit 37. The Vcc output terminal 34 is also configured to be detachably connected to the Vcc input terminal 14 of any one of the first through third battery packs 2 through 4 connected to the first charger 5.

The analog input terminal 35 is configured to receive the second power supply voltage Vcc through the pull-up resistor R2. The analog input terminal 35 is also configured to be detachably connected to the analog output terminal 15 of any one of the first through third battery packs 2 through 4 connected to the first charger 5. The analog input terminal 35 configured in this manner has a voltage equal to the second power supply voltage Vcc when (i) the first charger 5 is not connected to any of the first through third battery packs 2 through 4 and (ii) the analog input terminal 35 is open. When the first charger 5 is connected to any one of the first through third battery packs 2 through 4, the analog input terminal 35 is electrically coupled to the analog output generation circuit 23 of the connected battery pack, which causes the voltage at the analog input terminal 35 to fall below the second power supply voltage Vcc. The capacitor C1 of the connected battery pack is charged with the electric current drawn from the analog input terminal 35 into the capacitor C1 through the analog output terminal 15.

The second control circuit 36 is configured to transmit various signals to, and receive various signals from, other various circuits, thereby performing various control operations associated with charging of the first through third battery packs 2 through 4. Specifically, the second control circuit 36 is a microcomputer including a CPU, a memory, an I/O port, a SCI, a DAC, and an ADC, but is not limited thereto. In another embodiment, the second control circuit 36 may include an additional microcomputer. In yet another embodiment, the second control circuit 36 may include, in addition to or in place of the microcomputer, a logic circuit (or a wired logic connection) including two or more electronic components. In yet another embodiment, the second control circuit 36 may include, in addition to or in place of the microcomputer, a GPU, an ASIC, an ASSP, and/or a PLD.

The analog input terminal 35 described above is also coupled to the second control circuit 36. The second control circuit 36 is configured (or programmed) (i) to determine, in response to the analog input terminal 35 having a voltage equal to the second power supply voltage Vcc, that the first charger 5 is not connected to any of the first through third battery packs 2 through 4, and (ii) to determine, in response to the analog input terminal 35 having a voltage lower than the second power supply voltage Vcc, that the first charger 5 is connected to any one of the first through third battery packs 2 through 4.

The second power-supply circuit 37 is a switched-mode power-supply circuit (or a switched-mode AC-to-DC converter) configured to receive AC power of 100 to 130 volts or 220 to 240 volts from an external power supply (not shown) and to generate (i) the second power supply voltage Vcc, (ii) a charge voltage Vchg, and (iii) the charge current Ichg based on the received AC power. As mentioned above, the second power supply voltage Vcc is supplied to (i) the Vcc output terminal 34 and (ii) the pull-up resistor R2. The charge voltage Vchg is applied, through the positive and negative electrode terminals of the second power-supply circuit 37, between the second positive current path Lp2 and the second negative current path Ln2. The charge voltage Vchg is a DC voltage of 18 volts, but is not limited thereto. In another embodiment, the charge voltage Vchg may be a DC voltage of 40 volts, 14.4 volts, or 10.8 volts.

In addition, the second power-supply circuit 37 is configured to receive a PWM signal from the second control circuit 36 and to change the magnitude of the charge current Ichg according to the received PWM signal. The second control circuit 36 is configured (or programmed) to change a duty ratio (or a duty cycle) of the PWM signal in association with the change of the maximum required value Imax.

The AC voltage measurement circuit 38 is configured to measure an AC voltage Vac supplied to the second power-supply circuit 37 and to transmit an AC voltage measurement signal to the second control circuit 36. The AC voltage measurement signal is an analog signal having a variable voltage corresponding to a magnitude of the measured AC voltage Vac. The second control circuit 36 is configured (or programmed) to transmit, to the second power-supply circuit 37, the PWM signal reducing or stopping the charge current Ichg in response to the AC voltage measurement signal having a voltage falling outside its appropriate range. In another embodiment, the AC voltage measurement circuit 38 may be excluded from the first charger 5. Such a circuit configuration is, although less preferred, is encompassed within the scope of the present disclosure.

The second temperature measurement circuit 39 is configured to measure a temperature of the second power-supply circuit 37 (hereinafter referred to as the ‘power supply temperature Tsup’) using a not-shown temperature detection element (for example, a thermistor) and to transmit a second temperature measurement signal to the second control circuit 36. The second temperature measurement signal is an analog signal having a variable voltage corresponding to the power supply temperature Tsup. The second control circuit 36 is configured (or programmed) to transmit, to the second power-supply circuit 37, the PWM signal reducing or stopping the charge current Ichg (i) in response to the second temperature measurement signal having a voltage falling outside its appropriate level or (ii) in response to the second temperature measurement signal having a rapidly changing voltage. In another embodiment, the second temperature measurement circuit 39 may be excluded from the first charger 5. Such a circuit configuration, although less preferred, is encompassed within the scope of the present disclosure.

Each of the second charger 6 and the third charger 7 includes a circuit configuration similar to that of the first charger 5. In other words, each of the second charger 6 and the third charger 7 includes all the aforementioned components of the first charger 5.

However, the first through third chargers 5 through 7 differ from one another in terms of (i) specifications or characteristics of their respective components, (ii) signals transmitted from their respective second control circuits 36, and (iii) processes executed by their respective second control circuits 36.

One such difference is that the first through third chargers 5 through 7 (more specifically, their respective second power-supply circuits 37) have different upper limit values of the charge current Ichg. For this reason, the first through third chargers 5 through 7 (more specifically, their respective second control circuits 36 and their respective second power-supply circuits 37) are configured to be compatible with different charge controls.

Specifically, the first charger 5 is configured to be compatible with each of a first charge control, a second charge control, and a third charge control. Accordingly, the first charger 5 can perform the first through third charge controls. The first charge control sets (or adjusts or determines) the magnitude of the charge current Ichg in accordance with a first correlation profile. The second charge control sets (or adjusts or determines) the magnitude of the charge current Ichg in accordance with the second correlation profile. The third charge control fixes the magnitude of the charge current Ichg to a value lower than the third upper limit value.

The second charger 6 is incompatible with the first charge control while being compatible with the second and third charge controls. Accordingly, the second charger 6 can perform the second and third charge controls.

The third charger 7 is incompatible with the first and second charge controls while being compatible with the third charge control. Accordingly, the third charger 7 can perform only the third charge control.

### 2-4. Details of First and Second Correlation Profiles

The first and second correlation profiles are described in detail below.

### 2-4-1. First Correlation Profile

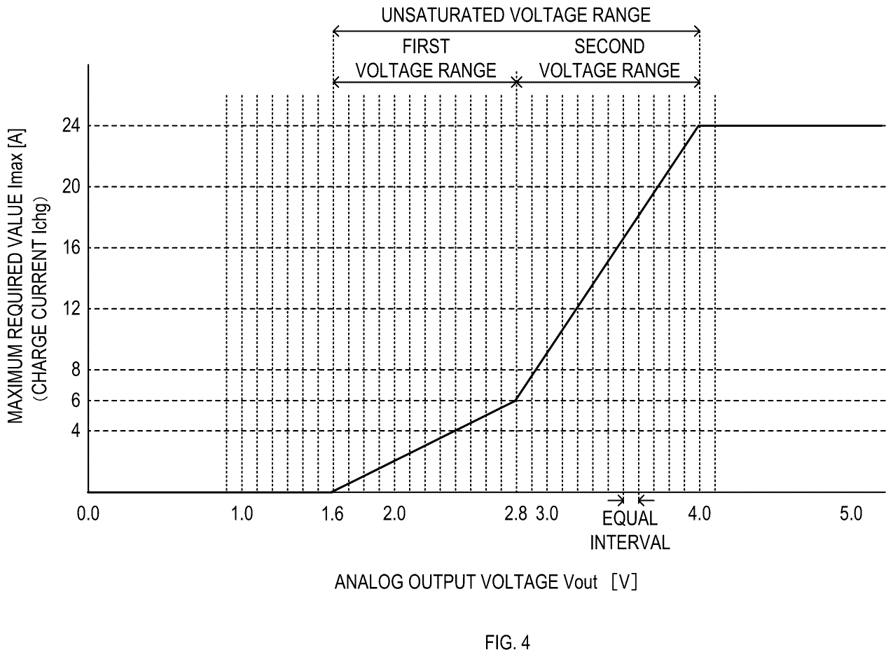

The first correlation profile (or correlation equation or correlation function) correlates the maximum required value Imax with the analog output voltage Vout such that the maximum required value Imax changes relative to the change of the analog output voltage Vout, as shown in FIG. 4.

As described above, the second control circuit 36 of the first charger 5 transmits, to the second power-supply circuit 37, the PWM signal corresponding to the maximum required value Imax. As a result, the magnitude of the charge current Ichg can also change relative to the change of the analog output voltage Vout, along the first correlation profile.

Specifically, the analog output voltage Vout is variable from zero volts to a level slightly lower than the second power supply voltage Vcc (i.e., 5 volts). In the first correlation profile, the analog output voltage Vout is correlated with the maximum required value Imax such that the maximum required value Imax changes from zero amperes to the first upper limit value (i.e., 24 amperes) within an unsaturated voltage range of the analog output voltage Vout, which is above zero volts and below 5 volts, more specifically, from 1.6 volts to 4 volts.

More specifically, the analog output voltage Vout has two divided ranges within its unsaturated voltage range: a first voltage range and a second voltage range. Each of the first voltage range and the second voltage range is further divided into 12 equal intervals (or unit segments). Each equal interval has a width of 0.1 volts.

The first voltage range extends from 1.6 volts to 2.8 volts. In this first voltage range, the maximum required value Imax is correlated with the analog output voltage Vout so as to change from zero to 6 amperes at a first rate of change (or a slope or a gradient). The first rate of change is set to 0.5 amperes per equal interval, that is, 0.5 amperes per 0.1 volts.

The second voltage range extends from 2.8 volts to 4 volts. In this second voltage range, the maximum required value Imax is correlated with the analog output voltage Vout so as to change from 6 to 24 amperes at a second rate of change. The second rate of change is set to three times the first rate of change, specifically, 1.5 amperes per equal interval, more specifically, 1.5 amperes per 0.1 volts.

In other words, the first correlation profile is set such that (i) the maximum required value Imax (consequently, the charge current Ichg) changes gradually within the first voltage range where the battery module 16 is almost fully charged and (ii) the maximum required value Imax changes sharply within the second voltage range where the charge level of the battery module 16 is low.

### 2-4-2. Second Correlation Profile

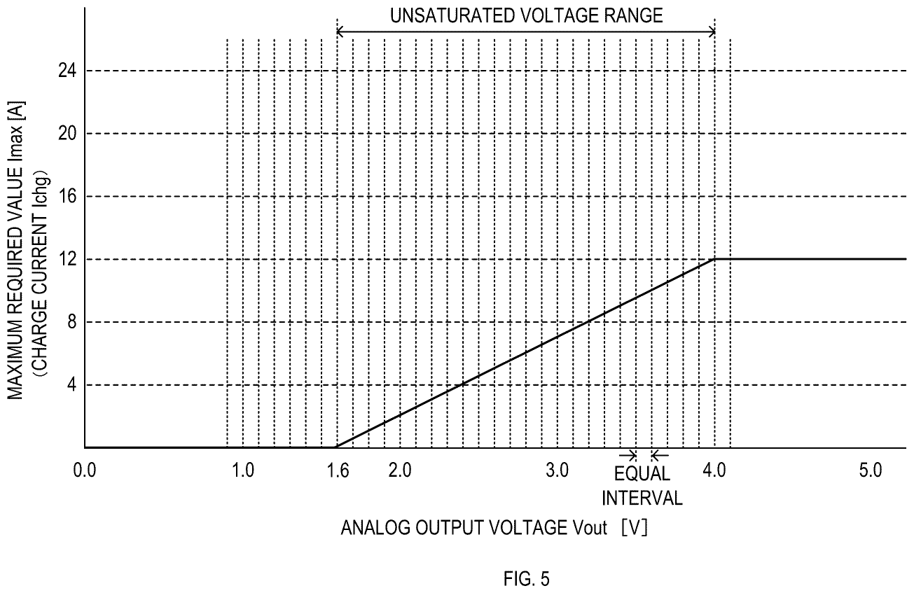

As shown in FIG. 5, the second correlation profile correlates the maximum required value Imax with the analog output voltage Vout such that the maximum required value Imax changes from zero amperes to the second upper limit value (i.e., 12 amperes) at a fixed rate of change within the unsaturated voltage range described above. The fixed rate of change is set to 0.5 amperes per equal interval, that is, 0.5 amperes per 0.1 volts.

### 2-5. Operation of Charging System

In the charging system 1 configured as described above, the first through third battery packs 2 through 4 can be combined with the first through third chargers 5 through 7 in the following ways:
First combination: the first battery pack 2 with the first charger 5;
Second combination: the first battery pack 2 with the second charger 6;
Third combination: the first battery pack 2 with the third charger 7;
Fourth combination: the second battery pack 3 with the first charger 5;
Fifth combination: the second battery pack 3 with the second charger 6;
Sixth combination: the second battery pack 3 with the third charger 7;
Seventh combination: the third battery pack 4 with the first charger 5;
Eighth combination: the third battery pack 4 with the second charger 6; and
Ninth combination: the third battery pack 4 with the third charger 7.

### 2-5-1. Operation of First, Fourth, or Seventh Combination

When any one of the first through third battery packs 2 through 4 is charged with the first charger 5, the charging system 1 operates as described below via serial communication between the first control circuit 18 of the connected battery pack and the second control circuit 36 of the first charger 5.

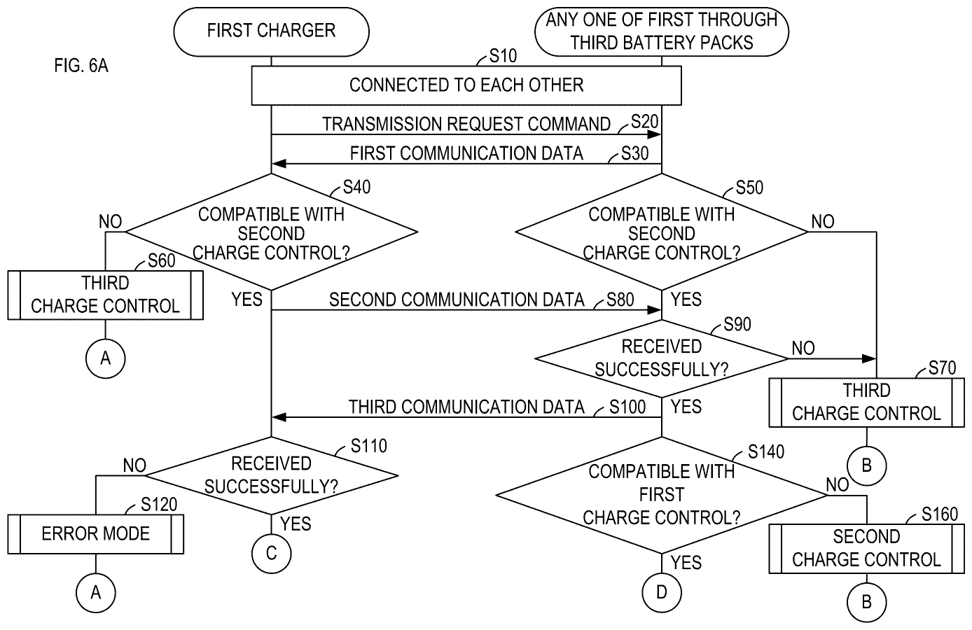

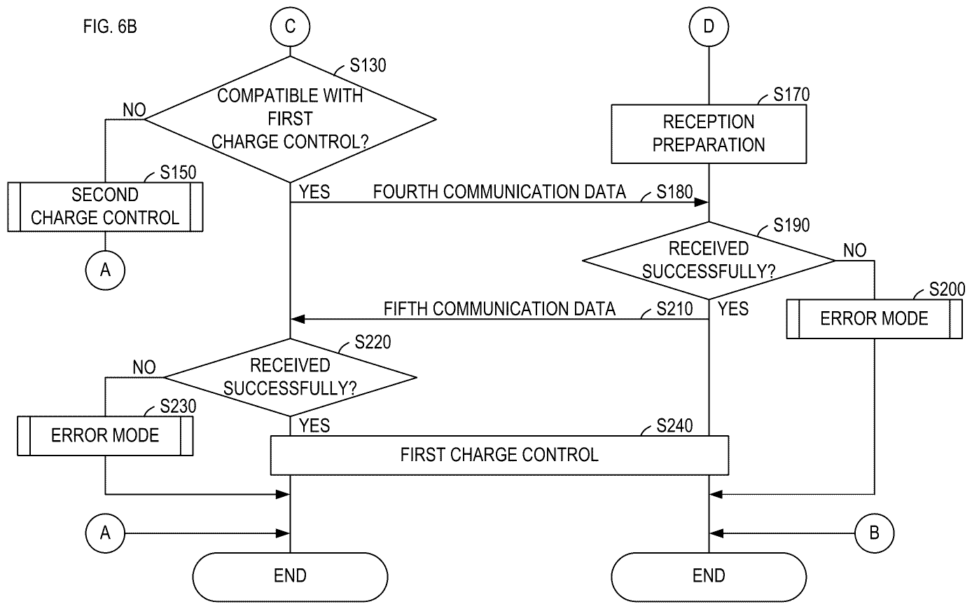

As shown in FIGS. 6A and 6B, when any one of the first through third battery packs 2 through 4 is connected to the first charger 5 (S10), the first charger 5 (more specifically, the second control circuit 36) transmits a transmission request command (S20) to the connected battery pack (more specifically, the first control circuit 18). The transmission request command requests the connected battery pack to provide information on the connected battery pack.

In response to the transmission request command, the connected battery pack transmits, to the first charger 5, first communication data as shown in Table 1 (S30).

TABLE 1
First Communication Data

| | |
|---|---|
| First Parameter | Battery Voltage |
| Second Parameter | Capacity |
| Third Parameter | Total Number of Charges |
| Fourth Parameter | Charge Control Compatibility |

As shown in Table 1, the first communication data includes first through fourth parameters, which indicate (i) the battery voltage Vbat, (ii) a capacity of the battery pack, (iii) the total number of charges to date, and (iv) the charge control compatibility, respectively.

The first communication data is converted into a serial digital signal including a bit sequence as shown in Table 2.

TABLE 2

| Battery Pack Type | (m-1)th byte | | | | | | | | mth byte | | | | | | | |
|---|---|---|---|---|---|---|---|---|---|---|---|---|---|---|---|---|
| First Battery Pack | x | x | x | x | x | x | x | 1 | x | 1 | x | x | x | x | x | x |
| Second Battery Pack | x | x | x | x | x | x | x | 0 | x | 1 | x | x | x | x | x | x |
| Third Battery Pack | x | x | x | x | x | x | x | 0 | x | 0 | x | x | x | x | x | x |

As shown in Table 2, the first communication data transmitted from each of the first through third battery packs 2 through 4 has a logical value in the (m-1)th byte (where m is any natural number greater than or equal to 2), the logical value indicating whether the respective battery pack is compatible with the first charge control. In addition, the first communication data includes another logical value in the mth byte, the logical value indicating whether the respective battery pack is compatible with the second charge control.

More specifically, the first communication data transmitted from the first battery pack 2 has logical values of “true (1)” for both the zeroth bit in the (m-1)th byte and the 6th bit in the mth byte. The combination of these logical values indicates that the first battery pack 2 is compatible with each of the first through third charge controls.

The first communication data transmitted from the second battery pack 3 has a logical value of “false (0)” for the zeroth bit in the (m-1)th byte and a logical value of “true (1)” for the 6th bit in the mth byte. The combination of these logical values indicates that the second battery pack 3 is incompatible with the first charge control while being compatible with the second and third charge controls.

The first communication data transmitted from the third battery pack 4 has logical values of “false (0)” for both the zeroth bit in the (m-1)th byte and the 6th bit in the mth byte. The combination of these logical values indicates that the third battery pack 4 is compatible only with the third charge control.

The second control circuit 36 of the first charger 5 is configured (or programmed) to identify logical values for both the zeroth bit in the (m-1)th byte and the 6th bit in the mth byte.

The second control circuit 36 of the second charger 6 is not configured (or not programmed) to identify a logical value for the zeroth bit in the (m-1)th byte, but is configured (or programmed) to identify a logical value for the 6th bit in the mth byte.

The second control circuit 36 of the third charger 7 is not configured (or not programmed) to identify logical values for both the zeroth bit in the (m-1)th byte and the 6th bit in the mth byte.

If the connected battery pack is incompatible with the second charge control (S40 and S50: NO), the first charger 5 and the connected battery pack perform the third charge control (S60 and S70).

If the connected battery pack is compatible with the second charge control (S40 and S50: YES), the first charger 5 transmits, to the connected battery pack, second communication data as shown in Table 3 (S80).

TABLE 3
Second Communication Data

| | |
|---|---|
| First Parameter | Upper Limit Value |
| Second Parameter | Charge Control Compatibility |
| Third Parameter | xxx |
| Fourth Parameter | xxx |

As shown in Table 3, the second communication data includes at least the first parameter and the second parameter, which indicate (i) an upper limit value of the charge current Ichg in the charger and (ii) the charge control compatibility, respectively.

The second communication data is converted into a serial digital signal including a bit sequence as shown in Table 4.

TABLE 4

| Charger Type | nth byte | | | | | | | |
|---|---|---|---|---|---|---|---|---|
| First Charger | x | 1 | x | x | x | x | x | x |

As shown in Table 4, the second communication data transmitted from the first charger 5 has a logical value of “true (1)” for the 6th bit in the nth byte (where n is any natural number greater than or equal to 1). This logical value indicates that the first charger 5 is compatible with each of the first through third charge controls.

The first control circuit 18 in each of the first battery pack 2 and the second battery pack 3 is configured (or programmed) to identify a logical value for the 6th bit in the nth byte.

The first control circuit 18 in the third battery pack 4 is not configured (or not programmed) to identify a logical value for the 6th bit in the nth byte.

If the connected battery pack fails to receive the second communication data within a specified period of time (S90: NO), the connected battery pack performs the third charge control (S70).

If the connected battery pack successfully receives the second communication data within the specified period of time (S90: YES), the connected battery pack transmits, to the first charger 5, a third communication data as shown in Table 5 (S100).

TABLE 5
Third Communication Data

| | | |
|---|---|---|
| First Parameter | Upper Limit of Maximum | 12 |
| | Required Value | |
| Second Parameter | Rate of Change | 0.5 |

As shown in Table 5, the third communication data includes the first parameter and the second parameter that define the second correlation profile. The first parameter indicates an upper limit of the maximum required value Imax. The second parameter indicates the change (i.e., the rate of change) of the maximum required value Imax per equal interval.

If the first charger 5 fails to receive the third communication data within the specified period of time (S110: NO), the first charger 5 transitions to its error mode (S120). In the error mode, the first charger 5 operates so as not to supply the charge current Ichg to the connected battery pack.

In the case where (i) the first charger 5 successfully receives the third communication data within the specified period of time (S110: YES) and (ii) the connected battery pack is incompatible with the first charge control (S130 and S140: NO), the first charger 5 and the connected battery pack (i.e., the second battery pack 3) perform the second charge control (S150 and S160).

If the connected battery pack is compatible with the first charge control (S130 and S140: YES), the connected battery pack (i.e., the first battery pack 2) initiates preparation for receiving fourth communication data (S170).

Subsequently, the first charger 5 transmits, to the first battery pack 2, the fourth communication data as shown in Table 6 (S180).

TABLE 6
Four Communication Data

| | |
|---|---|
| First Parameter | First Charger Information |
| Second Parameter | Second Charger Information |
| Third Parameter | xxx |
| Fourth Parameter | xxx |

As shown in Table 6, the fourth communication data includes at least the first parameter and the second parameter, which indicate (i) the first charger information and (ii) the second charger information, respectively. The first charger information and the second charger information are two sets of information on the first charger 5 required to perform the first charge control.

If the first battery pack 2 fails to receive the fourth communication data within the specified period of time (S190: NO), the first battery pack 2 transitions to its error mode (S200). In the error mode, the first battery pack 2 operates such that the charge current Ichg is not supplied from the first charger 5 to the first battery pack 2.

If the first battery pack 2 successfully receives the fourth communication data within the specified period of time (S190: YES), the first battery pack 2 transmits, to the first charger 5, fifth communication data as shown in Table 7 (S210).

TABLE 7
Fifth Communication Data

| | | |
|---|---|---|
| First Parameter | Rate of Change | 0.5 |
| Second Parameter | Number of Equal Intervals | 12 |
| Third Parameter | Rate of Change | 1.5 |
| Fourth Parameter | Number of Equal Intervals | 12 |
| Fifth Parameter | Rate of Change | 0 |
| Sixth Parameter | Number of Equal Intervals | 0 |
| Seventh Parameter | Rate of Change | 0 |
| Eighth Parameter | Number of Equal Intervals | 0 |
| Ninth Parameter | Rate of Change | 0 |
| Tenth Parameter | Number of Equal Intervals | 0 |

As shown in Table 7, the fifth communication data includes five pairs of parameters (the first through tenth parameters) defining the first correlation profile. Specifically, each pair indicates (i) the change (i.e., the rate of change) of the maximum required value Imax per equal interval and (ii) the number of equal intervals to which the rate of change is applied. More specifically, the first parameter indicates the change of the maximum required value Imax per equal interval in the first voltage range. The second parameter indicates the number of equal intervals in the first voltage range. The third parameter indicates the change of the maximum required value Imax per equal interval in the second voltage range. The fourth parameter indicates the number of equal intervals in the second voltage range. The first correlation profile includes 24 equal intervals in total in the unsaturated voltage range. Since the unsaturated voltage range can include no additional equal intervals, the 5th through 10th parameters are set to zero.

If the first charger 5 fails to receive the fifth communication data within the specified period of time (S220: NO), the first charger 5 transitions to the error mode as described above (S230).

If the first charger 5 successfully receives the fifth communication data within the specified period of time (S220: YES), the first charger 5 and the first battery pack 2 perform the first charge control (S240).

### 2-5-2. Operation of Second or Third Combination

When the first battery pack 2 is charged with the second charger 6 or the third charger 7, the charging system 1 operates as follows via serial communication between the first control circuit 18 in the first battery pack 2 and the second control circuit 36 in the connected charger.

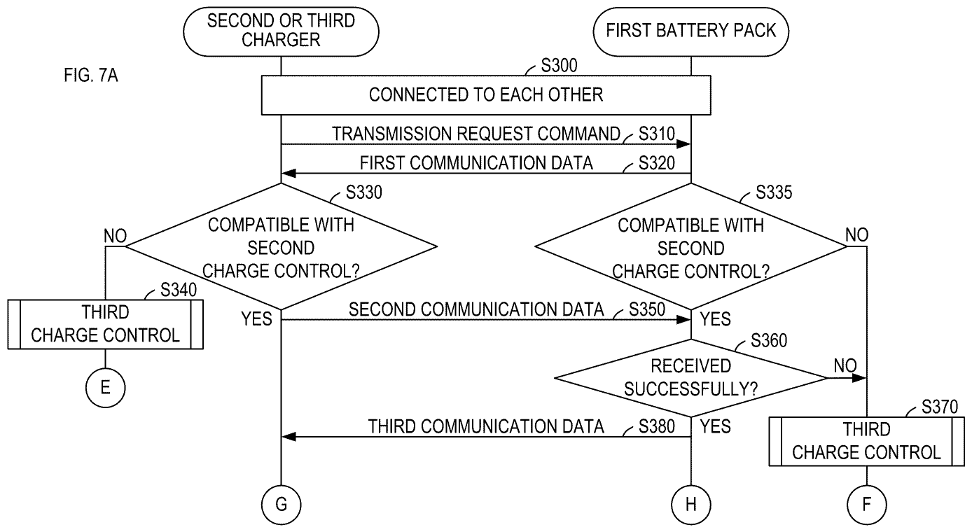

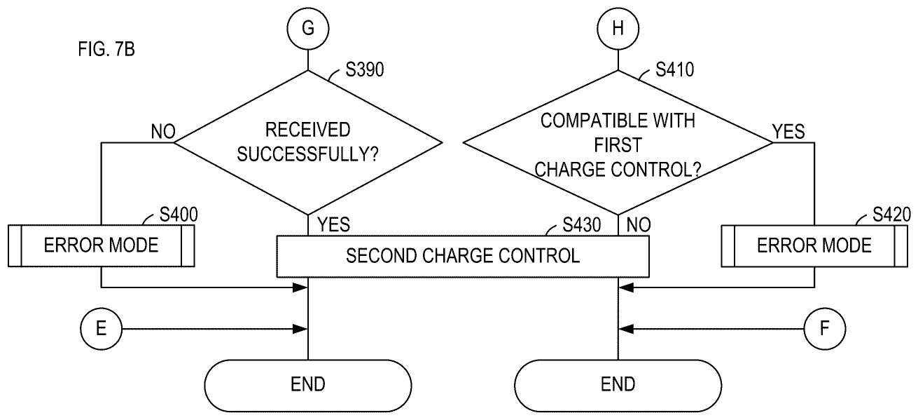

As shown in FIGS. 7A and 7B, when the first battery pack 2 is connected either to the second charger 6 or the third charger 7 (S300), the connected charger (more specifically, the second control circuit 36) transmits the transmission request command described above to the first battery pack 2 (more specifically, the first control circuit 18) (S310).

In response to the transmission request command, the first battery pack 2 transmits, to the connected charger, the first communication data described above (S320).

If the connected charger does not identify that the 6th bit in the mth byte in the first communication data has the logical value of “true (1)” and is incompatible with the second charge control (S330 and S335: NO), the charger (i.e., the third charger 7) and the first battery pack 2 perform the third charge control (S340 and S370).

If the connected charger identifies that the 6th bit in the mth byte in the first communication data has the logical value of “true (1)” and is compatible with the second charge control (S330: YES), the charger (i.e., the second charger 6) transmits, to the first battery pack 2, the second communication data described above (S350). The second communication data transmitted from the second charger 6 has the logical value of “false (0)” for the 6th bit in the nth byte. This logical value indicates that the second charger 6 is incompatible with the first charge control while being compatible with the second and third charge controls.

If the first battery pack 2 fails to receive the second communication data within the specified period of time (S360: NO), the first battery pack 2 performs the third charge control (S370).

If the first battery pack 2 successfully receives the second communication data within the specified period of time (S360: YES), the first battery pack 2 transmits, to the second charger 6, the third communication data described above (S380).

If the second charger 6 fails to receive the third communication data within the specified period of time (S390: NO), the second charger 6 transitions to its error mode (S400). In the error mode, the second charger 6 operates so as not to supply the charge current Ichg to the first battery pack 2.

If the first battery pack 2 erroneously determines that the second charger 6 is compatible with the first charge control (S410: YES), the first battery pack 2 transitions to its error mode due to not receiving the fourth communication data described above within the specified period of time (S420). In the error mode, the first battery pack 2 operates such that the charge current Ichg is not supplied from the second charger 6 to the first battery pack 2.

In the case where (i) the second charger 6 successfully receives the third communication data within the specified period of time (S390: YES) and (ii) the first battery pack 2 determines that the second charger 6 is incompatible with the first charge control (S410: NO), the second charger 6 and the first battery pack 2 perform the second charge control (S430).

### 2-5-3. Operation of Fifth, Sixth, Eighth, or Ninth Combination

When either the second battery pack 3 or the third battery pack 4 is connected to either the second charger 6 or the third charger 7, the operation of the charging system 1 is apparent to those skilled in the art with reference to FIGS. 6A, 6B, 7A, and 7B.

Accordingly, the descriptions of the operations of the charging system 1 for the fifth, sixth, eighth, and ninth combinations are omitted.

### 2-6. Detailed Operation of First Battery Pack in First Combination

The following describes in detail a first control process executed by the first control circuit 18 of the first battery pack 2 in the first combination.

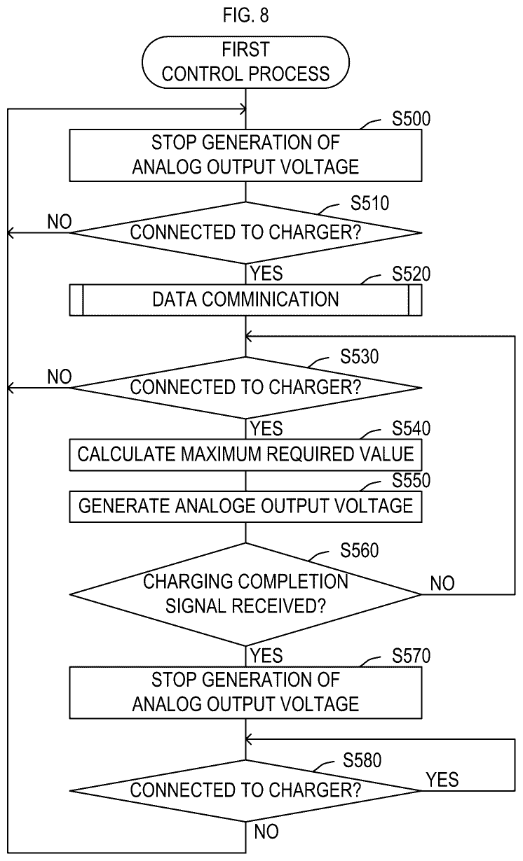

As shown in FIG. 8, in the first control process, the first control circuit 18 first stops generation of the analog output voltage Vout (S500). Specifically, the first control circuit 18 sets the duty ratio of the PWM signal to zero percent. As a result, the analog output voltage Vout is set to zero volts.

In the subsequent step S510, the first control circuit 18 determines whether the first battery pack 2 is connected to the first charger 5. If the first battery pack 2 is not connected to the first charger 5 (S510: NO), the first control circuit 18 returns to S500. If the first battery pack 2 is connected to the first charger 5 (S510: YES), the first control circuit 18 performs data communication with the first charger 5 (more specifically, the second control circuit 36 of the first charger 5) (S520). During this data communication, as already described with reference to FIGS. 6A and 6B, the transmission request command and the first through fifth communication data are transmitted and received between the first control circuit 18 and the first charger 5.

When the data communication is complete, the first control circuit 18 determines whether the first battery pack 2 is connected to the first charger 5 (S530). If the first battery pack 2 is not connected to the first charger 5 (S530: NO), the first control circuit 18 returns to S500.

If the first battery pack 2 is connected to the first charger 5 (S530: YES), the first control circuit 18 calculates the maximum required value Imax based on the identified battery voltage Vbat (S540). Subsequently, the first control circuit 18 identifies, from the first correlation profile, the analog output voltage Vout corresponding to the calculated maximum required value Imax, and sets the duty ratio of the PWM signal such that the analog output generation circuit 23 generates the identified analog output voltage Vout (S550).

In the subsequent step S560, the first control circuit 18 determines whether the first control circuit 18 has received a charging completion signal from the first charger 5 via serial communication. If the first control circuit 18 has not received the charging completion signal (S560: NO), the first control circuit 18 returns to S530.

If the first control circuit 18 has received the charging completion signal (S560: YES), the first control circuit 18 sets the duty ratio of the PWM signal to zero percent such that the analog output generation circuit 23 stops generation of the analog output voltage Vout (S570).

In the subsequent step S580, the first control circuit 18 determines whether the first battery pack 2 is connected to the first charger 5. If the first battery pack 2 is connected to the first charger 5 (S580: YES), the first control circuit 18 repeats S580. If the first battery pack 2 is not connected to the first charger 5 (S580: NO), the first control circuit 18 returns to S500.

### 2-7. Detailed Operation of First Charger in First Combination

The following describes in detail a second control process executed by the second control circuit 36 of the first charger 5 in the first combination.

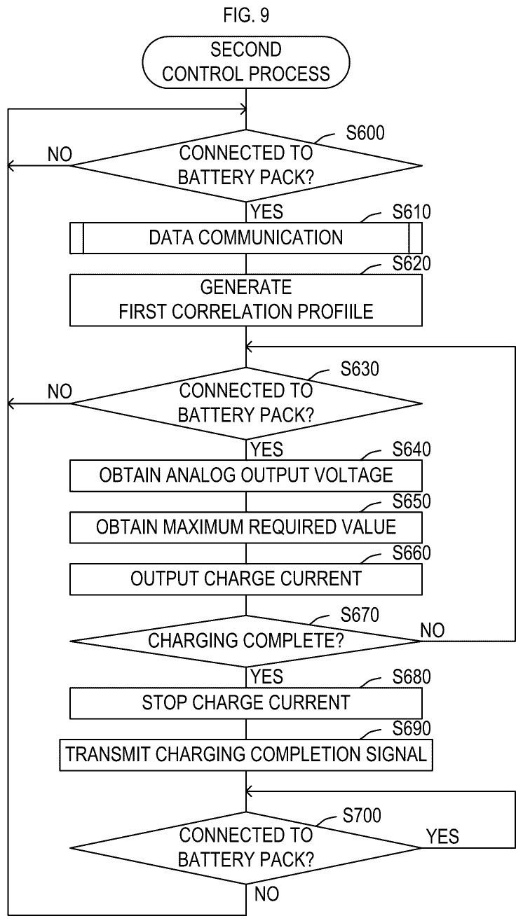

As shown in FIG. 9, in the second control process, the second control circuit 36 first determines whether the first charger 5 is connected to the first battery pack 2 (S600). If the first charger 5 is not connected to the first battery pack 2 (S600: NO), the second control circuit 36 repeats S600. If the first charger 5 is connected to the first battery pack 2 (S600: YES), the second control circuit 36 performs data communication with the first battery pack 2 (more specifically, the first control circuit 18 of the first battery pack 2) (S610). During this data communication, as already described with reference to FIGS. 6A and 6B, the transmission request command and the first through fifth communication data are transmitted and received between the second control circuit 36 and the first battery pack 2.

When the data communication is complete, the second control circuit 36 generates (or creates or constructs or derives) the first correlation profile based on the fifth communication data received from the first battery pack 2 (S620).

In the subsequent step S630, the second control circuit 36 determines whether the first charger 5 is connected to the first battery pack 2. If the first charger 5 is not connected to the first battery pack 2 (S630: NO), the second control circuit 36 returns to S600.

If the first charger 5 is connected to the first battery pack 2 (S630: YES), the second control circuit 36 obtains the analog output voltage Vout from the first battery pack 2 (S640). Then, based on (i) the obtained analog output voltage Vout and (ii) the generated first correlation profile, the second control circuit 36 obtains the maximum required value Imax (S650).

In the subsequent step S660, the second control circuit 36 sets the duty ratio of the PWM signal such that the second power-supply circuit 37 outputs the charge current Ichg with a magnitude corresponding to the obtained maximum required value Imax (S660).

In the subsequent step S670, the second control circuit 36 determines whether the charging of the first battery pack 2 is complete based on the obtained analog output voltage Vout. If the charging of the first battery pack 2 is not complete (S670: NO), the second control circuit 36 returns to S630. If the charging of the first battery pack 2 is complete (S670: YES), the second control circuit 36 sets the duty ratio of the PWM signal to zero percent such that the second power-supply circuit 37 stops output of the charge current Ichg (S680).

In the subsequent step S690, the second control circuit 36 transmits the charging completion signal to the first battery pack 2 via serial communication to determine whether the first charger 5 is connected to the first battery pack 2 (S700).

If the first charger 5 is connected to the first battery pack 2 (S700: YES), the second control circuit 36 repeats S700. If the first charger 5 is not connected to the first battery pack 2 (S700: NO), the second control circuit 36 returns to S600.

### 2-8. Effects of Embodiment

In the present embodiment as described above, the first combination of the first battery pack 2 with the first charger 5 can exhibit the effects as described below.

The maximum required value Imax can (i) change gradually when the analog output voltage Vout changes within the first voltage range and (ii) change sharply when the analog output voltage Vout changes within the second voltage range. Accordingly, the analog output voltage Vout enables precise control of the charge current Ichg such that overcharge of the battery module 16 is suppressed while shortening a charge time for the first battery pack 2.

The format of the fifth communication data makes it possible to reduce the volume of communication required for the first charger 5 to generate the first correlation profile. As a result, the likelihood that the first charger 5 fails to receive the fifth communication data can be reduced, and consequently, the first charge control can be performed in a stable manner between the first charger 5 and the first battery pack 2.

The format of the fifth communication data includes the first through tenth parameters, allowing not only simple correlation profiles but also more complex correlation profiles to be defined.

The analog output generation circuit 23 can generate the analog output voltage Vout in a stable manner by the capacitor C1.

### 2-9. Correspondence Between Terms

In the present embodiment, the “battery pack” described in Overview of Embodiments is exemplified by, but not limited to, the “first battery pack 2”. The “charger” described in Overview of Embodiments is exemplified by, but not limited to, the “first charger 5”. The “first voltage level” described in Overview of Embodiments is exemplified by, but not limited to, the “zero volts”. The “second voltage level” described in Overview of Embodiments is exemplified by, but not limited to, the “level slightly lower than 5 volts”. The “correlation profile” described in Overview of Embodiments is exemplified by, but not limited to, the “first correlation profile”. The “power-supply circuit” described in Overview of Embodiments is exemplified by, but not limited to, the “second power-supply circuit 37”.

### 2-10. Variations

The present disclosure can be implemented in variously modified manners without being limited to the embodiment described above.

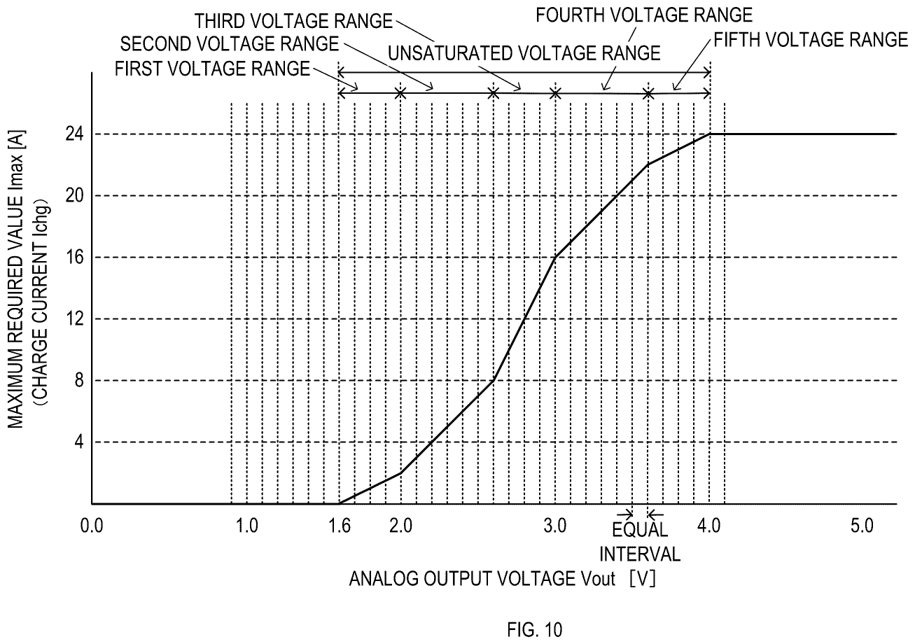

In one variation, the first correlation profile may be defined as shown in FIG. 10.

In the first correlation profile shown in FIG. 10, the analog output voltage Vout is divided into the first through fifth voltage ranges within the unsaturated voltage range.

The first voltage range extends from 1.6 volts to 2 volts and is divided into four equal intervals, each having a width of 0.1 volts. The rate of change for the maximum required value Imax in the first voltage range is set to 0.5 amperes per 0.1 volts.

The second voltage range extends from 2 volts to 2.6 volts and is divided into six equal intervals. The rate of change for the maximum required value Imax in the second voltage range is set to 1 ampere per 0.1 volts.

The third voltage range extends from 2.6 volts to 3 volts and is divided into four equal intervals. The rate of change for the maximum required value Imax in the third voltage range is set to 2 amperes per 0.1 volts.

The fourth voltage range extends from 3 volts to 3.6 volts and is divided into six equal intervals. The rate of change for the maximum required value Imax in the fourth voltage range is set to 1 ampere per 0.1 volts.

The fifth voltage range extends from 3.6 volts to 4 volts and is divided into four equal intervals. The rate of change for the maximum required value Imax in the fifth voltage range is set to 0.5 amperes per 0.1 volts.

When the first correlation profile is set in this way, the first control circuit 18 in the first battery pack 2 transmits, to the first charger 5, the fifth communication data as shown in Table 8.

TABLE 8
Fifth Communication Data

| | | |
|---|---|---|
| First Parameter | Rate of Change | 0.5 |
| Second Parameter | Number of Equal Intervals | 4 |
| Third Parameter | Rate of Change | 1.0 |
| Fourth Parameter | Number of Equal Intervals | 6 |
| Fifth Parameter | Rate of Change | 2.0 |
| Sixth Parameter | Number of Equal Intervals | 4 |
| Seventh Parameter | Rate of Change | 1.0 |
| Eighth Parameter | Number of Equal Intervals | 6 |
| Ninth Parameter | Rate of Change | 0.5 |
| Tenth Parameter | Number of Equal Intervals | 4 |

The first correlation profile set in this way allows for more precise control of the maximum required value Imax, and consequently, the magnitude of the charge current Ichg.

In a further variation, the first correlation profile may be defined as any function of the analog output voltage Vout (for example, an exponential function) having two or more different rates of change for the maximum required value Imax. In this case, the first control circuit 18 in the first battery pack 2 may transmit, to the second control circuit 36 in the first charger 5, the fifth communication data including a parameter indicating (or defining or characterizing or determining) such a function, and the second control circuit 36 may generate the first correlation profile based on the received function at S620.

### 2-11. Alternative Embodiments

In an alternative embodiment, the fifth communication data may include the first through tenth parameters as illustrated in, but not limited to, any of the following Tables 9, 10, or 11. Such fifth communication data, although less preferred, is encompassed within the scope of the present disclosure.

TABLE 9
Fifth Communication Data

| | | |
|---|---|---|
| First Parameter | Rate of Change | 1.0 |
| Second Parameter | Number of Equal Intervals | 24 |
| Third Parameter | Rate of Change | 0 |
| Fourth Parameter | Number of Equal Intervals | 0 |
| Fifth Parameter | Rate of Change | 0 |
| Sixth Parameter | Number of Equal Intervals | 0 |
| Seventh Parameter | Rate of Change | 0 |
| Eighth Parameter | Number of Equal Intervals | 0 |
| Ninth Parameter | Rate of Change | 0 |
| Tenth Parameter | Number of Equal Intervals | 0 |

TABLE 10
Fifth Communication Data

| | | |
|---|---|---|
| First Parameter | Rate of Change | 1.0 |
| Second Parameter | Number of Equal Intervals | 12 |
| Third Parameter | Rate of Change | 1.0 |
| Fourth Parameter | Number of Equal Intervals | 12 |
| Fifth Parameter | Rate of Change | 0 |
| Sixth Parameter | Number of Equal Intervals | 0 |
| Seventh Parameter | Rate of Change | 0 |
| Eighth Parameter | Number of Equal Intervals | 0 |
| Ninth Parameter | Rate of Change | 0 |
| Tenth Parameter | Number of Equal Intervals | 0 |

TABLE 11
Fifth Communication Data

| | | |
|---|---|---|
| First Parameter | Rate of Change | 1.0 |
| Second Parameter | Number of Equal Intervals | 5 |
| Third Parameter | Rate of Change | 1.0 |
| Fourth Parameter | Number of Equal Intervals | 5 |
| Fifth Parameter | Rate of Change | 1.0 |
| Sixth Parameter | Number of Equal Intervals | 5 |
| Seventh Parameter | Rate of Change | 1.0 |
| Eighth Parameter | Number of Equal Intervals | 5 |
| Ninth Parameter | Rate of Change | 1.0 |
| Tenth Parameter | Number of Equal Intervals | 4 |

### 2-12. Additional Remarks

Two or more functions performed by a single element of the above-described embodiments may be performed by two or more elements. One function performed by a single element may be performed by two or more elements. Two or more functions performed by two or more elements may be performed by a single element. One function performed by two or more elements may be performed by a single element. A portion of the configurations in the above-described embodiments may be omitted. At least a portion of the configuration in one embodiment may be added to or replace the configuration in another embodiment.

### 2-13. Further Aspects

In the aforementioned descriptions, as further aspects, the present disclosure provides:
1. A battery pack comprising:
a battery module configured (i) to receive a charge current from a charger and (ii) to be charged with the charge current; and
an analog output generation circuit configured (i) to generate an analog output voltage and (ii) to output the analog output voltage to the charger, the analog output voltage being variable among different voltage levels between a first voltage level and a second voltage level higher than the first voltage level; and
a control circuit configured (or programmed) (i) to control the analog output generation circuit to generate the analog output voltage corresponding to a charge level of the battery module and (ii) to transmit communication data to the charger, the communication data including five pairs of parameters for the charger to generate (or create) a correlation profile, the correlation profile correlating a change of a maximum required value of the charge current with each of 24 equal intervals in an unsaturated voltage range between the first voltage level and the second voltage level, the unsaturated voltage range including the different voltage levels, each pair of the five pairs of parameters including (i) a first parameter indicating a rate of change for the maximum required value and (ii) a second parameter indicating the number of equal intervals to which the rate of change indicated by the first parameter is applied, the charger being configured (i) to generate (or create) the correlation profile based on the five pairs of parameters, (ii) to change the maximum required value based on the analog output voltage and the correlation profile, and (iii) to change a magnitude of the charge current in response to the change of the maximum required value.
2. The battery pack according to aspect 1,
wherein the control circuit is configured (or programmed) to control the analog output generation circuit such that the analog output voltage decreases in accordance with an increase in the charge level.
3. The battery pack according to aspect 1 or 2, wherein:
the correlation profile is defined by at least one pair and at most four pairs among the five pairs of parameters; and
each remaining pair of the five pairs of parameters indicates a value of zero.
4. The battery pack according to any one of aspects 1 through 3,
where the control circuit is configured (or programmed) to transmit the communication data to the charger via serial communication with the charger.
5. The battery pack according to any one of aspects 1 through 4,
wherein the analog output generation circuit includes a capacitor and a semiconductor switch, and is configured such that the capacitor generates the analog output voltage by being charged or discharged through the semiconductor switch.
6. The battery pack according to aspect 5,
wherein the control circuit is configured (or programmed) to transmit, to the semiconductor switch, a pulse-width modulated signal having a duty ratio (or a duty cycle) corresponding to the maximum required value to thereby control a switching operation of the semiconductor switch.
7. A charger comprising:
a power-supply circuit configured (i) to generate a charge current and (ii) to output the charge current to a battery pack; and
a control circuit configured (or programmed) (i) to receive an analog output voltage and communication data from the battery pack, (ii) to generate (or create) a correlation profile based on five pairs of parameters included in the communication data, (iii) to change a maximum required value of the charge current based on the analog output voltage and the correlation profile, and (iv) to control the power-supply circuit to change a magnitude of the charge current in response to a change of the maximum required value, the analog output voltage being variable among different voltage levels between a first voltage level and a second voltage level higher than the first voltage level, the correlation profile correlating the change of the maximum required value with each of 24 equal intervals in an unsaturated voltage range between the first voltage level and the second voltage level, the unsaturated voltage range including the different voltage levels, each pair of the five pairs of parameters including (i) a first parameter indicating a rate of change for the maximum required value and (ii) a second parameter indicating the number of equal intervals to which the rate of change indicated by the first parameter is applied.
8. A charging system comprising:
a battery pack; and
a charger,
the battery pack including:
a battery module configured (i) to receive a charge current from the charger and (ii) to be charged with the charge current;
an analog output generation circuit configured (i) to generate an analog output voltage and (ii) to output the analog output voltage to the charger, the analog output voltage being variable among different voltage levels between a first voltage level and a second voltage level higher than the first voltage level; and
a first control circuit configured (or programmed) (i) to control the analog output generation circuit to generate the analog output voltage corresponding to a charge level of the battery module and (ii) to transmit communication data to the charger, the communication data including five pairs of parameters for the charger to generate (or create) a correlation profile, the correlation profile correlating a change of a maximum required value of the charge current with each of 24 equal intervals in an unsaturated voltage range between the first voltage level and the second voltage level, the unsaturated voltage range including the different voltage levels, each pair of the five pairs of parameters including (i) a first parameter indicating a rate of change for the maximum required value and (ii) a second parameter indicating the number of equal intervals to which the rate of change indicated by the first parameter is applied,
the charger including:
a power-supply circuit configured (i) to generate the charge current and (ii) to output the charge current to the battery pack; and
a second control circuit configured (or programmed) (i) to receive the analog output voltage and the communication data from the battery pack, (ii) to generate (or create) the correlation profile based on the five pairs of parameters included in the communication data, (iii) to change the maximum required value based on the analog output voltage and the correlation profile, and (iv) to control the power-supply circuit to change a magnitude of the charge current in response to the change of the maximum required value.
9. A method for charging a battery pack with a charger, the method comprising:
outputting an analog output voltage from the battery pack to the charger, the analog output voltage being variable among different voltage levels between a first voltage level and a second voltage level higher than the first voltage level;
transmitting communication data from the battery pack to the charger, the communication data including five pairs of parameters for the charger to generate (or create) a correlation profile, the correlation profile correlating a change of a maximum required value of a charge current for charging the battery pack with each of 24 equal intervals in an unsaturated voltage range between the first voltage level and the second voltage level, the unsaturated voltage range including the different voltage levels, each pair of the five pairs of parameters including (i) a first parameter indicating a rate of change for the maximum required value and (ii) a second parameter indicating the number of equal intervals to which the rate of change indicated by the first parameter is applied;
generating (or creating) the correlation profile, in the charger, based on the five pairs of parameters included in the communication data; and
changing the maximum required value, in the charger, based on the analog output voltage and the correlation profile to thereby control a magnitude of the charge current.

In each of aspects 1, and 7 through 9, it is possible to control the charge current more precisely with the analog output voltage if the first parameter (i.e., the rate of change) and the second parameter (i.e., the number of equal intervals) are properly set. In addition, since only five pairs of parameters are transmitted from the battery pack to the charger, it is possible to reduce the volume of communication required for the charger to generate the correlation profile. As a result, the likelihood that the charger fails to receive the communication data can be reduced, and consequently, stable charge control can be performed between the charger and the battery pack.

What is claimed is:

1. A battery pack comprising:
a battery module configured (i) to receive a charge current from a charger and (ii) to be charged by the charge current;
an analog output generation circuit configured (i) to generate an analog output voltage and (ii) to output the analog output voltage to the charger, the analog output voltage being variable among different voltage levels between a first voltage level and a second voltage level higher than the first voltage level; and
a control circuit configured (i) to control the analog output generation circuit to generate the analog output voltage corresponding to a charge level of the battery module and (ii) to transmit communication data to the charger, the communication data including parameters for the charger to generate a correlation profile, the correlation profile correlating a maximum required value of the charge current with the analog output voltage such that the maximum required value changes at two or more rates of change while the analog output voltage is transitioning among the different voltage levels, the charger being configured to change the maximum required value based on the analog output voltage and the correlation profile to thereby control a magnitude of the charge current.

2. The battery pack according to claim 1, wherein:
the analog output voltage has an unsaturated voltage range including the different voltage levels between the first voltage level and the second voltage level;
the unsaturated voltage range is divided into at least two voltage ranges in the correlation profile; and
the maximum required value changes at different rates of change across adjacent voltage ranges of the at least two voltage ranges in the correlation profile.

3. The battery pack according to claim 2, wherein:
the control circuit is configured to control the analog output generation circuit to decrease the analog output voltage in accordance with an increase in the charge level;
the at least two voltage ranges include (i) a first voltage range and (ii) a second voltage range adjacent to and higher than the first voltage range; and
in the correlation profile, the maximum required value has a first rate of change in the first voltage range and a second rate of change higher than the first rate of change in the second voltage range.

4. The battery pack according to claim 3,
wherein the second rate of change is three times the first rate of change.

5. The battery pack according to claim 3, wherein:
the unsaturated voltage range is divided into 24 equal intervals; and
a total number of equal intervals included in the first voltage range is equal to a total number of equal intervals included in the second voltage range.

6. The battery pack according to claim 2, wherein:
the unsaturated voltage range is divided into 24 equal intervals; and
the parameters include at least two pairs of parameters, each pair of the at least two pairs of parameters including (i) a first parameter indicating a rate of change for the maximum required value and (ii) a second parameter indicating the number of equal intervals to which the rate of change indicated by the first parameter is applied.

7. The battery pack according to claim 6,
wherein the at least two pairs of parameters are five pairs of parameters.

8. The battery pack according to claim 7, wherein:
the correlation profile is defined by at least two pairs and at most four pairs among the five pairs of parameters; and
each remaining pair of the five pairs of parameters indicates a numerical value of zero.

9. The battery pack according to claim 1,
wherein the control circuit is configured to transmit the communication data to the charger via serial communication with the charger.

10. The battery pack according to claim 1,
wherein the analog output generation circuit includes a capacitor and a semiconductor switch, and is configured such that the capacitor generates the analog output voltage by being charged or discharged through the semiconductor switch.

11. The battery pack according to claim 10,
wherein the control circuit is configured to transmit, to the semiconductor switch, a pulse-width modulated signal having a duty ratio corresponding to the maximum required value to thereby control a switching operation of the semiconductor switch.

12. A charger comprising:
a power-supply circuit configured (i) to generate a charge current and (ii) to output the charge current to a battery pack; and
a control circuit configured (i) to receive an analog output voltage and communication data from the battery pack, (ii) to change a maximum required value of the charge current based on the analog output voltage and parameters included in the communication data, and (iii) to control the power-supply circuit to change a magnitude of the charge current in response to a change of the maximum required value, the analog output voltage being variable among different voltage levels between a first voltage level and a second voltage level higher than the first voltage level, the parameters correlating the maximum required value with the analog output voltage such that the maximum required value changes at two or more rates of change while the analog output voltage is transitioning among the different voltage levels.

13. A charging system comprising:
a battery pack; and
a charger,
the battery pack including:
a battery module configured (i) to receive a charge current from the charger and (ii) to be charged by the charge current; and
an analog output generation circuit configured (i) to generate an analog output voltage and (ii) to output the analog output voltage to the charger, the analog output voltage being variable among different voltage levels between a first voltage level and a second voltage level higher than the first voltage level; and
a first control circuit configured (i) to control the analog output generation circuit to generate the analog output voltage corresponding to a charge level of the battery module and (ii) to transmit communication data to the charger, the communication data including parameters for the charger to generate a correlation profile, the correlation profile correlating a maximum required value of the charge current with the analog output voltage such that the maximum required value changes at two or more rates of change while the analog output voltage is transitioning among the different voltage levels,
the charger including:
a power-supply circuit configured (i) to generate the charge current and (ii) to output the charge current to the battery pack; and
a second control circuit configured (i) to receive the analog output voltage and the communication data, (ii) to generate the correlation profile based on the parameters included in the communication data, (iii) to change the maximum required value based on the analog output voltage and the correlation profile, and (iv) to control the power-supply circuit to change a magnitude of the charge current based on the maximum required value.

14. A method for charging a battery pack with a charger, the method comprising:
outputting an analog output voltage from the battery pack to the charger, the analog output voltage being variable among different voltage levels between a first voltage level and a second voltage level higher than the first voltage level;
receiving, at the charger, the analog output voltage; and
changing, at the charger, a maximum required value of a charge current for charging the battery pack based on the analog output voltage and a correlation profile to thereby control a magnitude of the charge current, the correlation profile correlating the maximum required value with the analog output voltage such that the maximum required value changes at two or more rates of change while the analog output voltage is transitioning among the different voltage levels.
